(19) United States
(12) Patent Application Publication
(10) Pub. No.: US 2002/0047856 A1
(43) Pub. Date: Apr. 25, 2002

(54) Web based stacked images

(76) Inventor: Ronald K. Baker, Richboro, PA (US)

Correspondence Address: RICHARD F. JAWORSKI, Cooper & Dunham LLP, 1185 Avenue of the Americas, New York, NY, 10036, US

(21) Appl. No.: 09/778,998

(22) Filed: Feb. 7, 2001

Related U.S. Application Data
(60) Provisional application No. 60/180,734, filed on Feb. 7, 2000.

(51) Int. Cl. G09G 5/00

(52) U.S. Cl. 345/700

(57) ABSTRACT

A method of providing web-based stacked images, includes providing a database of image data, the image data representing a plurality of separate images, displaying at least a portion of the plurality of separate images, creating a stack of image data by individually selecting images from the displayed images, wherein each time an image is selected, the image data representing the selected image is pushed onto the stack of image data, the stack of image data including information defining an order in which the selected images are to be displayed and assigning a tag to the stack of image data, uniquely identifying the stack of image data, the tag being included in the stack of image data.

This application claims the benefit of provisional application Ser. No. 60/180,734 filed Feb. 7, 2000.

### BACKGROUND

1. Field of the Disclosure

The present application relates to a method of displaying images and, more particularly, to a method of displaying stacked images allowing a user to flip through the images without having to download a new web page for each image.

2. Description of the Related Art

The World Wide Web (WWW) is a system which allows information created by users on servers (“Web pages” or simply “pages”) to be retrieved and read via communication lines from all around the world. Each web page has an identification assigned thereto referred to as a Uniform Resource Locator (URL).

The information contained in the pages is typically written in a language referred to as Hypertext Markup Language (HTML). An HTML document includes a hierarchical set of markup elements, where most elements have a start tag, followed by content information and then an end tag. The content information is typically a combination of text and nested markup elements. The tags indicate how the document is structured and how to display the document, and may include destinations and labels for hypertext links. There are tags for markup elements including titles, headers, text attributes, paragraph identification information, links to other documents or other parts of the same document, in-line graphic images, and many other features.

Browser software provided on a user system can be used to retrieve and interpret the pages of information for displaying the information on the screen of the user's system. One well known example of a browser is Netscape Navigator developed by Netscape Communications Corporation.

Although a user can select and download a desired page by designating the URL for the page, the use of URLs can often be tedious and troublesome. That is, having to enter the URL to move between different pages can be a time consuming and often confusing procedure. Alternative methods of moving between pages of information can be found on many different browsers. For example, different information can be viewed by using the “forward” and “backward” buttons found on many browsers. However, using such a system, the user must still first display each page either by entering its URL or by moving intially to the page by use of a hyperlink. The user can then move back and forth between pages previously displayed by using the “forward” and “back” buttons provided on the browser. However, this method of viewing information still requires each page to be downloaded each time it is viewed, which is a time consuming procedure. The method can also be confusing since the user may become “lost” by moving back and forth between pages, particularly when many pages having a lot of information are involved.

Another method inlvolves the use of book marks. If the browser is provided with a bookmark function, when a user reads information on a particular web page, the read page is registered as a bookmark. After the user has moved to another page, the user can immediately return to a desired page by designating the registered bookmark. Although a bookmark function realizes easier access to a page which has already been read, without the need for inputting or selecting a URL each time the user desires to read the page, the bookmark function still has drawbacks.

For example, the bookmark function still requires each page to be downloaded each time the corresponding bookmark is selected. In addition, the bookmark function accumulates URLs of the web pages which are viewed. The URLs are registered as bookmarks in the order of viewing. Accordingly, when it is desired to collectively display the URLs of pages containing similar or related information in a bookmark listing area, the user must perform an operation of reordering the bookmarks. That is, it is necessary to reorder the bookmarks so as to manage the URLs of the pages containing similar or related information as one group. This operation can be very troublesome, particularly when the number of registered bookmarks is large.

There are various ways of displaying information from different pages. For example, HTML allows information displayed by a network browser to split a displayed image into a number of rectangular areas called “frames”. Each frame can display a separate HTML document or other type of HTML object (e.g., an image) specified by a separate URL. This allows, for example, text to be displayed in one frame, a photographic image to be displayed in another frame, an animated sequence to be displayed in another frame and navigational aids such as graphical toolbars to be displayed in yet another frame. By clicking on the graphical toolbars using a mouse or other pointing device, the contents of the other displayed frames can be updated.

A problem with HTML frames is that arbitrary HTML documents cannot be “nested”. That is, when a HTML frame is displayed, the HTML document displays HTML information in the frame. The frame behaves like a static window used by the application to display the information. If reference is made to another HTML document in the first HTML document using, for example, a link, URL, reference tags, etc., the new HTML document is read in and laid out in the HTML frame, replacing the first HTML document's display and layout characteristics. This effectively prevents any arbitrary HTML document from being nested within another HTML document.

Accordingly, other HTML documents cannot be displayed within a first HTML document without overwriting all of the layout and display characteristics of the first HTML document. <FRAME> and <FRAMESET> tags in HTML, although not allowing arbitrary document nesting, do allow some degree of nesting. However, the containing document is required to be a <FRAME> document which has restricted layout characteristics. Although HTML frames allow documents to be displayed side-by-side, they do not allow overlapping or true nesting of documents.

A need exists for an easy and efficient way to view multiple images one at a time, without having to download a new web page for each image and providing improved versatility in the images displayed.

### SUMMARY OF THE DISCLOSURE

A method of providing web-based stacked images, comprises providing a database of image data, the image data representing a plurality of separate images and displaying at least a portion of the plurality of separate images. A stack of image data is created by individually selecting images from the displayed images, wherein each time an image is selected, the image data representing the selected image is pushed onto the stack of image data, the stack of image data including information defining an order in which the selected images are to be displayed. A tag is assigned to the stack of image data, uniquely identifying the stack of image data, the tag being included in the stack of image data. The method may further comprise selecting additional information to be included with the stack of image data, the additional information relating to the images in the stack of image data. The additional information may include tags correlating portions of the additional information to corresponding images. A portion of the additional information corresponding to an image on a top of the stack may be displayed when each image is displayed on the top of the stack. The image may comprise magazine cover images. The additional information may further describes contents of magazines represented by the magazine cover images. The additional information may comprise a website address on the Internet which includes information further describing contents of magazines represented by the magazine cover images. The additional information may comprise a hyperlink. The stack of image data may be created in response to a request by a user. The order in which the selected images are to be displayed can vary from user to user, based on information included in the request. The images selected to be included in the stack can vary from user to user, based on information included in the request. The information included in the request is in a form of a cookie retrieved from the user's computer. The information included in the request may be used to retrieve user preference information from a database of user preference information.

According to another aspect of the present disclosure, a server is disclosed for providing web-based stacked images. The server comprises a database of image data, the image data representing a plurality of separate images. A display displays at least a portion of the plurality of separate images. A processing unit creates a stack of image data by individually selecting images from the displayed images, wherein each time an image is selected, the image data representing the selected image is pushed onto the stack of image data, the stack of image data including information defining an order in which the selected images are to be displayed, the processing unit assigning a tag to the stack of image data, uniquely identifying the stack of image data, the tag being included in the stack of image data.

According to another aspect, a datastream for transmission across the Internet, comprises image data representing a plurality of images, information describing an order in which the plurality of images are to be displayed on a user's computer, wherein the images are arranged in a stack, with only a top image to be displayed at a time, and descriptive information describing aspects of the plurality of images, wherein the descriptive information includes information correlating portions of the descriptive information to at least a portion of each of the plurality of images.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a flow chart of a method of preparing a stack of images according to an embodiment of the present disclosure;

FIG. 2 is a flow chart of a method of performing the user interface for displaying and viewing the stacked images;

FIGS. 3 and 4 are flow charts of methods of downloading the stacked images to the user's system;

FIG. 5 is a flow chart of a method of modification or formation of the stack of images according to user preference and/or behavior;

FIG. 6 is a block diagram of a user system according to an embodiment of the present disclosure;

FIG. 7 is a schematic diagram of a network connected system according to an embodiment of the present disclosure;

FIG. 8 is a diagram of a display window according to an embodiment of the present disclosure;

FIG. 9 is a diagram of a display window showing a stack of images and additional information displayed;

FIG. 10 is a diagram of a menu selection window; and

FIG. 11 is a block diagram of a server according to an embodiment of the present disclosure.

### DETAILED DESCRIPTION

In describing preferred embodiments of the present disclosure illustrated in the drawings, specific terminology is employed for sake of clarity. However, the present disclosure is not intended to be limited to the specific terminology so selected and it is to be understood that each specific element includes all technical equivalents which operate in a similar manner.

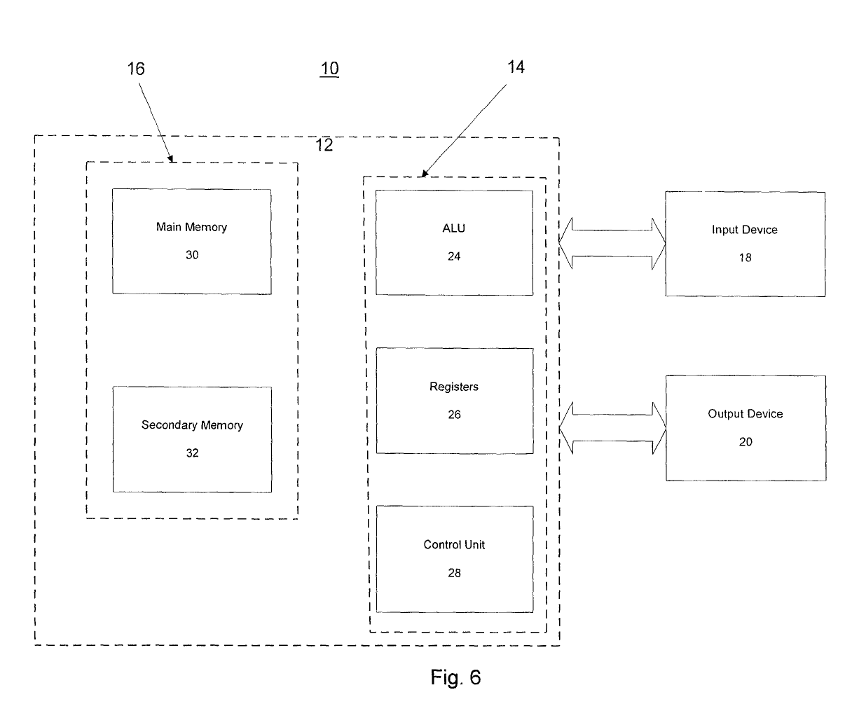

Referring now to FIG. 6, an operating environment according to an embodiment includes a computer system 10. Computer system 10 includes a computer 12 having a central processing unit (CPU) 14, a memory system 16, input device 18 and output device 20.

CPU 14 includes an arithmetic logic unit (ALU) 24 for performing computations. Registers 26 are provided for temporary storage of data and instructions. Control unit 28 controls operation of the computer system 10. Any of a variety of known processors may be used to implement CPU 14. In addition although only one CPU is shown, computer system 10 may alternatively be implemented using multiple processing units.

Memory system 16 includes a main memory 30 and secondary memory 32. Main memory 30 typically includes a high speed random access memory (RAM) and read only memory (ROM). Of course, main memory 30 can also include an additional or alternative high speed device or memory circuit. Secondary memory 32 typically includes long term storage devices such as ROM, optical and/or magnetic disks, organic memory, and/or any other type of volatile or non-volatile mass storage system. Or course, memory 16 can include a variety and/or combination of alternative components.

Input device 18 and output device 20 may include well known devices for inputting information to and outputting information from computer 12. For example, input device 18 can a keyboard, mouse, pointing device, audio device such as a microphone, for example, and/or any other type of device providing input to the computer 12 including MODEM, network connection, etc. Output device 20 may include a display, printer, MODEM, network connection, etc.

As well known in the art, computer system 10 typically further includes an operating system and at least one application program. The operating system is software which controls the computer system's operation and the allocation of resources. The application program is software that performs a task desired by the user. The application program makes use of computer resources made available through the operating system. Both the operating system and the at least one application program may be resident in the memory system 16.

In accordance with the practices of a person skilled in the art, the present disclosure is described below with reference to acts and symbolic representations of operations that are performed by computer system 10, unless indicated otherwise. Such acts and operations are sometimes referred to as being computer-executed. It will be appreciated that the acts and symbolically represented operations include the manipulations by the CPU 14 of electrical signals representing data bits which causes a resulting transformation or reduction of the electrical signal representation and the maintenance of data bits for memory allocation in memory system 16 to thereby reconfigure or otherwise alter the computer system's operation as well as other processings of the signals. The memory allocations where data bits are maintained are physical locations that have particular electrical, magnetic, optical or organic properties or combinations thereof corresponding to the data bits.

The data bits may also be maintained on a computer readable medium including magnetic disks, and other volatile or non-volatile mass storage system readable by the computer 12. The computer readable medium includes cooperating or interconnective computer readable medium, which exist exclusively on the computer system 10 or are distributed among multiple inter-connective computer systems 10 that may be local or remote.

In an illustrative embodiment of the present disclosure, computer system 10 uses a Windows operating system. However, other types of operating systems are contemplated for use in implementing the present disclosure.

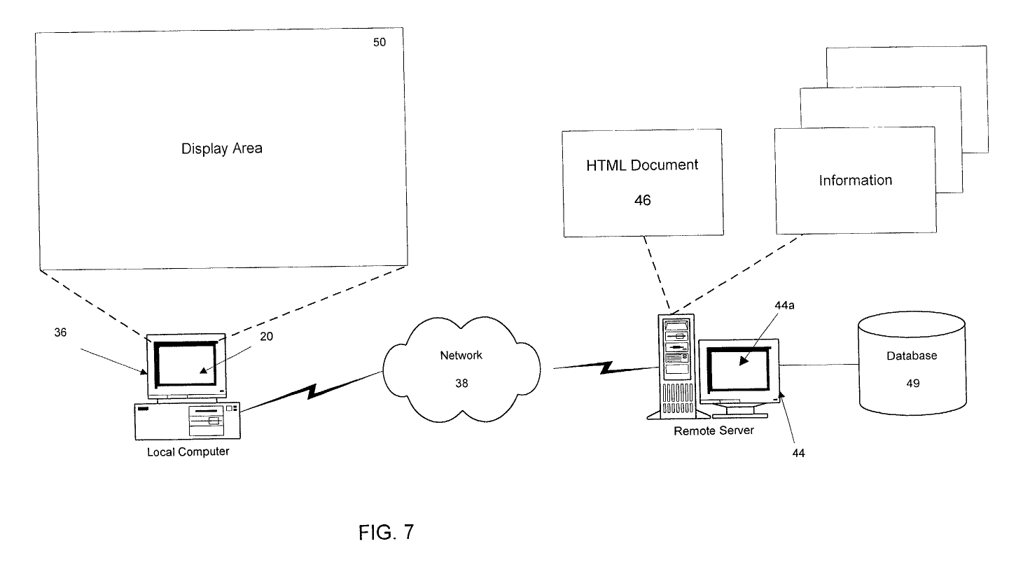

FIG. 7 shows a browsing environment according to an illustrative embodiment of the present disclosure. A local computer 36 may consist of a computer system 10 such as that shown in FIG. 6. Computer 36 runs software, referred to herein as a browser, for unified browsing of electronic documents or other data from local sources and from a computer network 38. The browser can be an integrated browser integrated with operating system software or can be a separate operation software program remote from or installed on local computer 36. Computer network 38 can be the Internet, an intranet, Local Area Network (LAN) or other type of computer network or a combination thereof. In the illustrative embodiment of a browsing environment, the local computer 36 may connect to the computer network 38 via a telephone modem, cable modem 42, etc., for example. Of course, other connections to the computer network 38 may alternatively be used, such as ISDN, T1, DSL or other high speed telecommunications connections using an appropriate connection device, such as a television cable and modem, a satellite link, an optical fiber link, local area technology, wire and adaptive cord, radio or optical transmission devices, etc., or combinations thereof. Of course, when implemented over the Internet, computer network 38 may also include various Internet Service Providers (ISPs) (not shown).

Documents for browsing with the browser provided on local computer 36 can reside as files of a file system stored in the computer's secondary storage, or reside as resources at a remote server 44 (also referred to as a site or store) connected to the computer network 38. Such sites may reside, for example, as a WWW site on the Internet. The illustrated document 46 residing at the remote server 44 conforms with the HTML standards, and may include extensions and enhancements of the HTML standards. Of course, the browser provided on local computer 36 can also browse documents having other data formats originating from local computer 36 or remote server 44. In conformance with HTML, the illustrative document 46 can incorporate additional information content such as graphical images, audio, video, executable programs, etc. which also reside at the remote server 44 or other remote servers/computers. The document 46 and any additional information may be stored as files in a file system of the remote server 44. The HTML document 46 incorporates the additional information using HTML tags and uniform resource locators (URL's) that specify the location of files or other Internet resources containing the necessary images and/or information on the computer network 38. Of course, other locating formats may also be used.

When used for browsing documents, the browser on local computer 36 downloads and displays the document in a window 50 or area of the display 20 allocated to the browser by the operating system. The window 50 may include a display area and user interface controls (not shown). Of course, other display formats may also be used.

An embodiment of the present disclosure delivers multiple raster (bitmap quality) images from a web-based remote computer server machine such as remote server 44 to the browser-based desktop machine 36 via standard Internet protocols over network 38 without the typical page refresh required by users.

According to an embodiment, a “stack” of images can be downloaded from server 44 to computer 36 and displayed in a document display area of window 50. The stack of images displayed allows a user to “flip” through multiple images without having to jump to a new page for each image. An illustrative embodiment is described herein with respect to the use of magazine cover images as the images which are stacked. However, it should be understood that the use of any type of images or other types of information is also contemplated hereon. According to an embodiment of the present disclosure, the stacked images can be “flipped” through by the user simply by placing the cursor on the top image and right clicking on the top image. Each time the user clicks on the top image, the next image on the stack is displayed. The previous top image is then moved to the bottom of the stack. The user can thus individually view the next image in the stack by clicking on the top image.

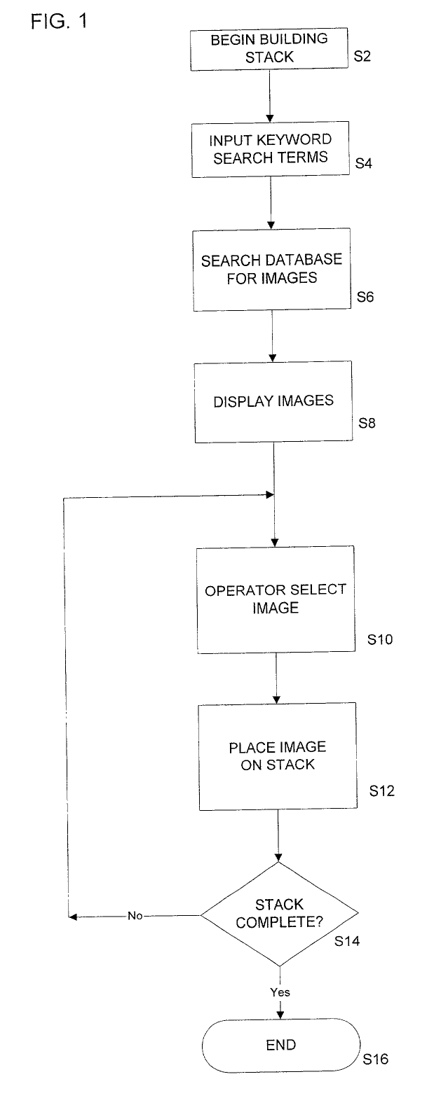

The convention associated with the type of delivery mechanism described herein is referred to herein as the stack. The stack is a data structure having the ease and convenience of a first-in last-out (FILO) device. As will be described in more detail below with respect to FIG. 1, stacks are built on a web-based remote server 44, using raster bitmapped graphic images controlled by application program interfaces (API) and are primarily intended for viewing by users on personal computers such as a local computer 36. Although, described herein using bitmapped graphic images, the use of images presented using other types of formats including grid-based character protocols are also contemplated.

When creating the stack, an API controls the order of the stack, which remains open to accepting varying instructions. When images are selected by an operator to be included in the stack, they are “pushed” onto the stack. When the API has completed its instructions for the stack, the stack is packaged and uniquely tagged, for example, with a URL for delivery to users. When a user of local computer 36 selects a web-based page that contains a tag corresponding to a stacked image, the stack is downloaded to local computer 36 in compressed format and stored in memory. Using browser-based plug-in software applets, the stack of images is decompressed and displayed. The user can then flip through the images, or “pop” them off of the stack in the reverse order they were packaged. Users benefit by viewing many images targeted for their use one at a time and in one page location. Users are spared the effort of requesting a new page to be downloaded and waiting for the page to be refreshed with a new image in the way standard image delivery is performed (i.e., one image per page location). As an additional benefit, data tags may be packaged with and displayed with the images for ease of reference, as will be described later below.

FIG. 1 depicts in more detail a conceptual flow chart for building a stack of images according to an embodiment of the present disclosure. As described herein, the building of the stack of images may be performed on remote server 44. Of course, the stack of images may be built on another system and the stack then downloaded to remote server 44. When an operator begins building a stack (Step S2), images are selected from a database of images. For example, according to an illustrative embodiment, remote server 44 includes a database 49. Database 49 includes images depicting the covers of various types of magazines. An operator building a stack of images at server 44 relating to particular subject matter, can flip through the images and choose, for example, magazine covers relating to a particular subject or related subjects. For example, database 49 may include images of magazine covers relating to cars, travel, boating, audio systems, gardening, finance, etc. Remote server 44 may be provided with relational database software which searches database 49 for appropriate magazine cover images based on keywords input by the operator. Of course, other methods of searching database 49 may be provided.

After the operator inputs an appropriate keyword search term(s) (Step S4) a search of database 49 for images related to the search term(s) is performed (Step S6) and any images found during the search are displayed (Step S8). The magazine cover images found during the search may be displayed one at a time on display 44a or can be displayed side by side in rows and columns or in any other suitable format. The operator reviews the magazine cover images. When a desired magazine cover image is found, the image is selected by the operator (Step S8) by, for example, clicking on the image. The image is then placed onto the stack (Step S12). If the stack is not complete (No, Step S14), the next desired magazine cover image is selected by the operator (Step S4) and the process repeats. When it is determined that the stack is complete (Yes, Step S14), either by a predefined operator input (e.g. hitting a predefined key or key sequence) or by the input of a predefined number of images to the stack, the completed stack is uniquely tagged, appropriate identifiers assigned thereto and the stack package is stored in memory. Database 49 may include additional information relating to each of the images selected, as will be described in more detail below. As each image is selected and placed in the stack, any additional information corresponding to the image is also tagged appropriately and packaged along with the stack. The stack creating process then ends (Step S16). The server 44 can include many different predefined stacks of images. As will be described later below, the stacks can be generated based on user preferences.

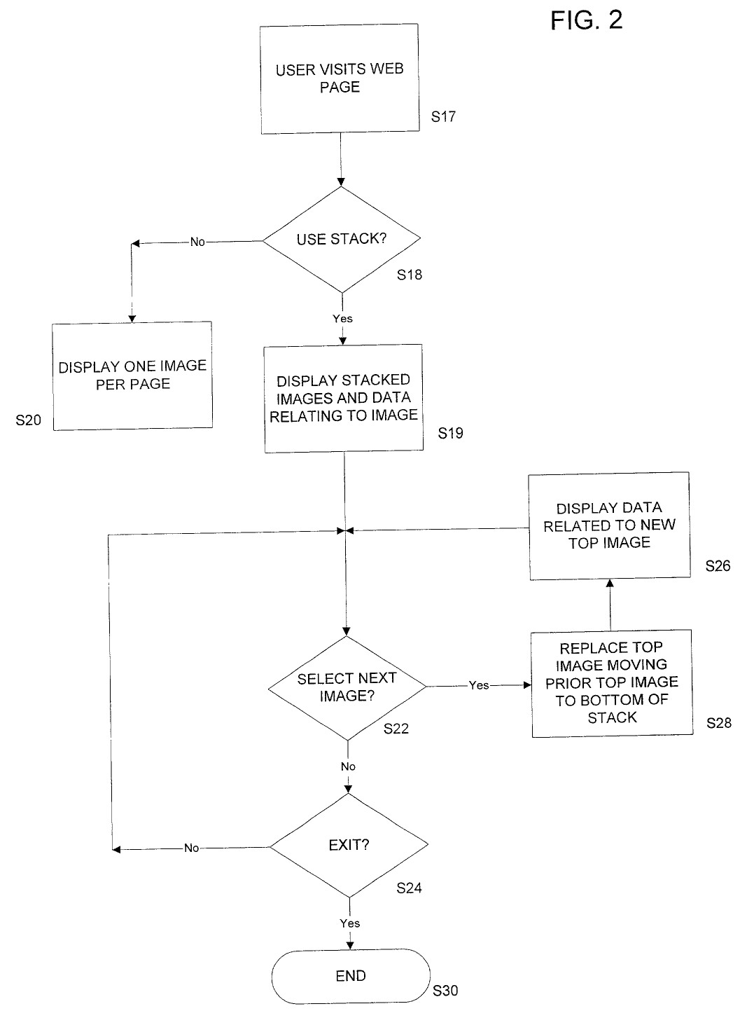

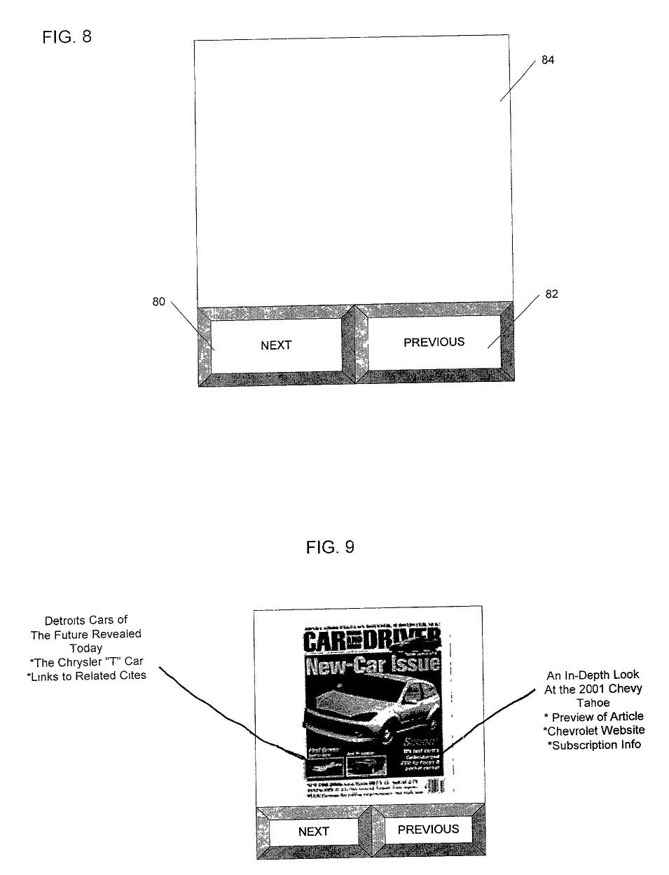

As shown in FIG. 2, when, a user visits a website (e.g., remote server 44) to view a web page (Step S17), the user's browser determines whether the website includes a “stacked” image according to an embodiment of the present disclosure. Of course, multiple stacked sets of images may be provided at the site. That is, the site or page may include one or more stacks of images each having a tag associated therewith identifying it as being a “stacked” image. In Step S18, it is determined by the browser whether the displayed image is a “stacked” image. If No in Step S18 (the page does not include a stacked image), normal web page viewing (e.g., one image per page) is performed (Step S20). If Yes in Step S18 (the page includes a stacked image), the stack package is downloaded to the user's system, decompressed and displayed (Step S19). The stack package may include additional information related to each image which can be displayed with the image. As each image is displayed on the top of the stack, the additional information relating to the top image may then be displayed in a field on another portion of the display. According to an embodiment, the top image is clicked on to select and view the next image in the stack (Yes, Step S22). The top image is then placed on the bottom of the stack and the next image in the stack is displayed, along with any additional information relating thereto (Step S28). This process can be repeated indefinitely for repeatedly viewing images in the stack. In the alternative, as shown in FIG. 8, the system can be arranged to include a “NEXT” image button 80 and a “PREVIOUS” image button 82. By selectively clicking buttons 80, 82, the user can flip back and forth through the stacked images. The images and any additional information are displayed in display area 84. Other embodiments may include “FIRST” image and “LAST” image buttons and even a slide bar for greater navigational ease through the stacked images.

As noted above, as each new image is displayed on the top of the stack, data related to the top image can also be displayed in a separate image field on the screen. This additional information can include promotional information, catalog information or additional information related to the image presently displayed on the top of the stack. For example, as shown in FIG. 9, an image depicting the cover of “CAR AND DRIVER” magazine may be displayed on the top of the stack. Other portions of the display can display tie-ins to the magazine such as information describing articles in this months issue and/or upcoming issues, special sale items, information on how to subscribe, etc. For example, the CAR AND DRIVER magazine image may have additional information associated therewith which describes the issue in more detail. The additional information may describe in more detail an article appearing in this months issue. Underneath the article might be hyperlinks to more stacked image packages relating to the subject of the article and/or hyperlinks to other websites related to the subject of the article or magazine. When the user clicks the browser's exit button to leave the page (Yes, Step S24), the process ends.

A more detailed description of the technical performance of the delivery of the stack will now be described. Delivery of the stack to a user's computer is accomplished by using standard publicly available image compression algorithms and browser-based plug-in software applets. Stacks are delivered to browser-based local computer via publicly available image compression algorithms in conjunction with standard Internet protocols on-demand initiated by users who select a stack to view.

When a user of local computer 36 clicks on the stack on a web page built according to an embodiment of the present disclosure, such as at server 44, the browser on local computer 36 determines which stack to display and whether there is more than one stack tag on the page. The browser also determines where to initiate the request for the stack, either from the server 44 for new requests or on the local computer 36 for old requests. In either case, the packaged stack is delivered in compressed format to the local computer and delivered to a browser-based plug-in software applet for decompression. The applet then decompresses and builds the stack of images on the user's computer, and displayed for user interaction.

The present stacked based image system may include a dynamic user interface preference option whereby users can override the default order of the stack for the purposes of resorting the images or skipping over images based on individual preferences. These preferences can be determined through the applet and can be stored on the user's desktop machine in standard cookie format.

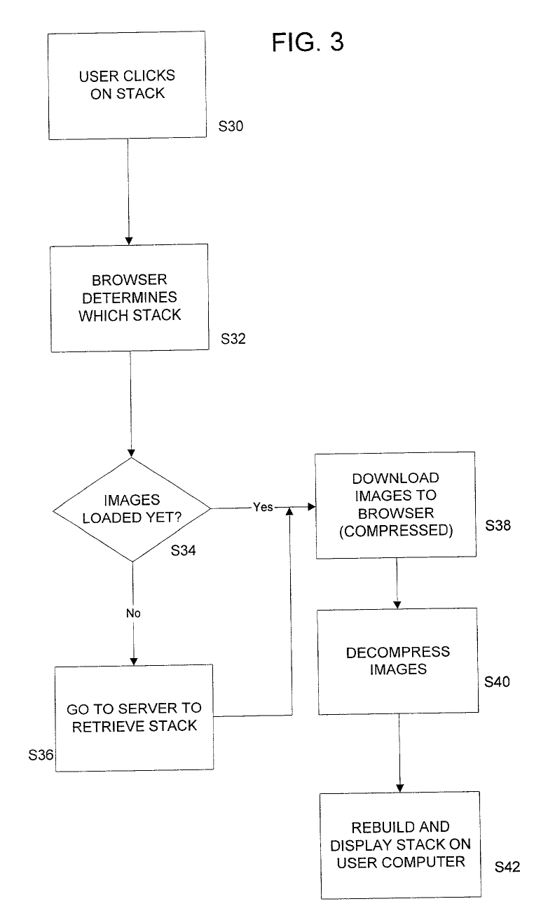

FIG. 3 is a technical flow chart further detailing access and use of the stack according to an embodiment of the present disclosure. When a user enters a website and clicks on a stack (Step S30), the browser identifies the stack (Step S32), for example, by viewing the tag associated with the stack. A determination is made whether the images and related information associated with the stack have been previously loaded to the user's machine (Step S34). This may be accomplished by comparing the tag associated with the stack to any cookies stored on the user's computer. If it is a new request and the images and information have not been previously loaded to the user's computer (No, Step S34), the server having the stack of images is accessed and the images for the stack are retrieved (Step S36). The images are downloaded from server 44 to the user's browser in compressed format and stored (Step S38). If it is a repeat request for a previously viewed stack of images, and the images and information have already been loaded to the user's computer and are still stored therein (Yes, Step S34), the images and information are then retrieved from user's memory to the user's browser (Step S38).

According to another embodiment, a further determination can be made in Step S34 to determine whether any additional information corresponding to the images previously loaded into the user's computer need to be updated. This can be done by comparing a predefined tag associated with this additional information currently stored on the user's computer, with information at server 44 indicating the most current additional information for that stack of images. If updating is necessary, the new information can then be downloaded to the user's computer. After the images and associated information are loaded, the images and associated information are then decompressed (Step S40) and the stack is rebuilt and displayed on the user's computer (Step S42).

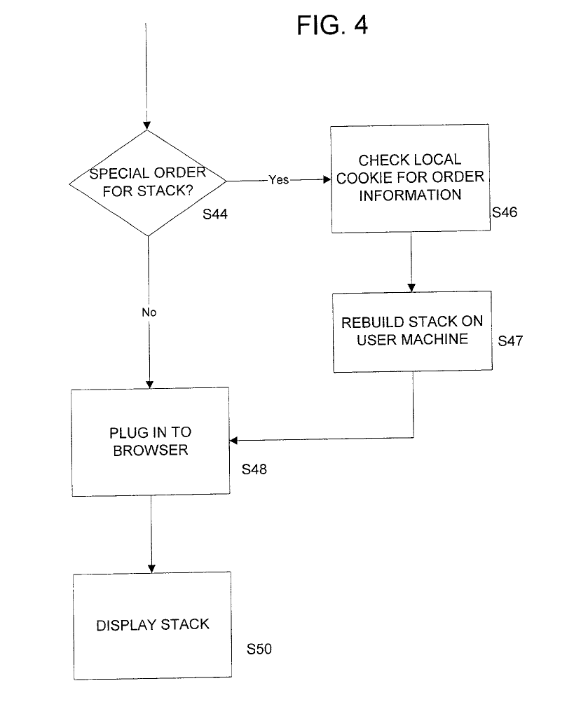

According to another embodiment of the present disclosure, a dynamic user preference option may be provided. According to this embodiment, the user can override the default order in which the images are placed in the stack, resorting the images or skipping over images based on individual preference. For example, the user's preference can be stored in standard cookie format on the user's computer. As shown in FIG. 4, if the stack is to be placed in a special order (Yes, Step S44) (e.g., based on previous user preference, etc), the user's computer is checked for a local cookie (Step S46). The local cookie may contain information indicating past user preferences. The stack is then reordered in accordance with the past user preferences (Step S47). If No in Step S44 or after the images are reordered, the stack of images are plugged into the user's browser (Step S48). The stack is then displayed (Step S50). The display may include “NEXT” and “PREVIOUS” image navigation buttons, allowing the user to even more easily navigate through the stacked images.

The stack of images can also be created to order by the user based on user preference. A server side script is an executable program, or a set of commands stored in a file, that can be run by a server program to produce an HTML document that is then returned to a Web browser. Typical script actions include running applications to retrieve information from a database and creating an HTML document with the retrieval information. The script may be run on the Web server when, for example, the end user submits an HTML form request for a stack of images relating to a subject for which a preformed stack does not exist. For example, a Web server according to an embodiment may have an interface for running external programs, such as a Common Gateway Interface (CGI). The CGI is a program that handles incoming information requests and returns the appropriate document or generates a document dynamically. According to an embodiment of the present disclosure, a gateway may have the capability of receiving a request from a user for defined image types, searching a database for images and information relating to the request and translating the images and information into a stack of images with related information which can then be sent to the user as a stack. The gateway program may be written in a language such as “C” or in a scripting language such as Practical Extraction and Report Language (PERL) or Tool Control Language (TCL) or one of the Unix operating system shell languages. The CGI standard specifies how the script or application receives input and parameters, and specifies how any output should be formatted and returned to the server.

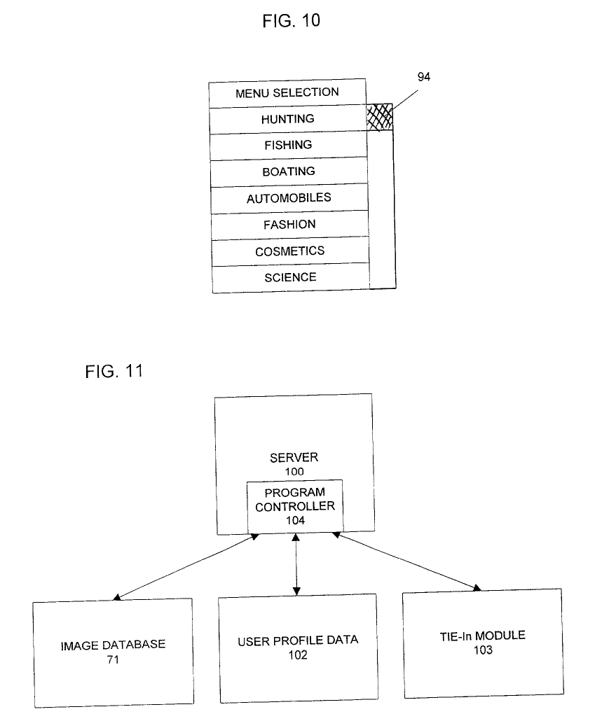

When a user visits a website using stacked image technology according to this embodiment of the present disclosure, including a CGI, an initial screen view or home page is displayed. According to an embodiment, the home page provides pull/down/scroll menu selections for user selection of magazine covers related to particular subjects from among many different subjects. For example, as shown in FIG. 10, the page may include a subject selection menu 92 that can be pulled down and scrolled using scroll bar 94 to display various topics 90. The user can then select the subject of “Hunting”, for example, by using scroll bar 94 to highlight the “HUNTING” category and then left clicking on it. The CGI also records the user's selections and his viewing activity and can store that information on the user's machine 62 in the form of a cookie or in a separate database. Upon subsequent trips to the website, the cookie can be retrieved from the user's machine or the database and the user preference information associated therewith used to target specific promotions, advertisements, etc. so that they can be displayed to that user.

A detailed description of a remote server system 100 capable of generating stacked images based on a user's past use, is shown in FIG. 11. The server system 100 according to this embodiment includes an image database 101 (in this embodiment a magazine cover image database) for storing images. A user profiling database 102 records information regarding each user derived from each user's past visits to the website. This information may include the user's ID, categories of interest and any user display preferences. The user profiling database 102 can be a database provided at the server 100 or remotely accessible by server 100. To reduce cost of operating the server, the user profiling database 102 may be in the form of cookies as mentioned above, which can be stored in and can be retrieved from the user's own system. Tie-in Module 103 holds tie-in information such as advertisement information, sale items, information regarding subscriptions, etc. for each image (e.g., each magazine cover image) stored in database 101.

Program controller 104 is a series of routines or methods performed on server 100. Program controller 104 responds to commands such as log-in commands, menu selections, etc., transmitted over the Internet, for example, to server 100 by an end user. Program controller 104 obtains the necessary information from image database 101, user profiling member 102 and Tie-in module 103 to generate an appropriate stack of images. The stack of images is packaged along with the Tie-in information corresponding to the selected images.

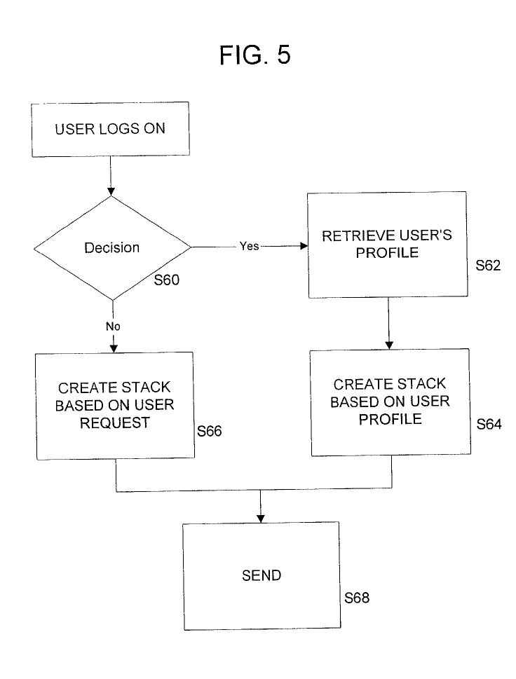

More specifically, as shown in FIG. 5, in response to user login, controller 104 determines whether the user has previously logged onto the website or is a new user of the website (Step S60). If the user has previously logged onto the website (Yes, Step S60), the user's profile is retrieved from user profile data 102 (Step S62). As noted above this can be done by retrieving cookies from the user's machine or by retrieving information from a separate database if cookies are not available or not used. Using the user preference information obtained from the user profile data, the image database and Tie-in module, a stack of images is generated and packaged with the Tie-in information which can be targeted to the user (Step S64). If the user is new to the site, and has requested a specific type or types of information (No, Step S60), a premade stack of images is selected or a new stack of images is created, based on the request (Step S66). Controller 104 transmits the package via the Internet, to the user system 36 for display.

Controller 104 obtains sets of information from Tie-in Module 103 for each image selected during the stack building process. Each set of information is tagged to correlate it to its corresponding image. Accordingly, when the stack is displayed at the user's system 36, the set of information corresponding to the top image on the stack can be displayed.

As described herein, server-side programming in conjunction with relational database technology power the server-side stack technology. In the data flow diagrams, stacks may be built with images according to instructions supplied by web applications and communicated via an applications program interface (API). These APIs reference technology according to the present disclosure to build a customized stack according to the order of the images and data specified. Embodiments of the present disclosure use server-side programming to build the stack and relational databases to store the specifications of the stack. In addition, embodiments of the present disclosure use relational database technology to store individual user preferences before they are transmitted and stored on the user's desktop in the form of a cookie. On the user's desktop, embodiments of the present disclosure use the plug-in applet to drive the display and navigational features of the stack for the benefit of the user.

The present disclosure allows stacked raster images to be delivered from web-based server machines to browser-based desktop machines via standard Internet protocols. The stack can be displayed with navigation buttons allowing the user to flip through the stacked images without the page refresh typically required.

In describing preferred embodiments of the present disclosure illustrated in the drawings, specific terminology is employed for sake of clarity. However, the present disclosure is not intended to be limited to the specific terminology so selected and it is to be understood that each specific element includes all technical equivalents which operate in a similar manner.

The present disclosure may be conveniently implemented using one or more conventional general purpose digital computers and/or servers programmed according to the teachings of the present specification. Appropriate software coding can readily be prepared by skilled programmers based on the teachings of the present disclosure. The present disclosure may also be implemented by the preparation of application specific integrated circuits or by interconnecting an appropriate network of conventional component circuits, as will be readily apparent to those skilled in the art.

Numerous additional modifications and variations of the present disclosure are possible in view of the above-teachings. It is therefore to be understood that within the scope of the appended claims, the present disclosure may be practiced other than as specifically described herein.

What is claimed is:

1. A method of providing web-based stacked images, comprising:
providing a database of image data, the image data representing a plurality of separate images;
displaying at least a portion of the plurality of separate images;
creating a stack of image data by individually selecting images from the displayed images, wherein each time an image is selected, the image data representing the selected image is pushed onto the stack of image data, the stack of image data including information defining an order in which the selected images are to be displayed; and
assigning a tag to the stack of image data, uniquely identifying the stack of image data, the tag being included in the stack of image data.

2. A method as recited in claim 1, further comprising selecting additional information to be included with the stack of image data, the additional information relating to the images in the stack of image data.

3. A method as recited in claim 2, wherein the additional information includes tags correlating portions of the additional information to corresponding images.

4. A method as recited in claim 2, wherein a portion of the additional information corresponding to an image on a top of the stack is displayed when each image is displayed on the top of the stack.

5. A method as recited in claim 2, wherein the images comprises magazine cover images.

6. A method as recited in claim 5, wherein the additional information further describes contents of magazines represented by the magazine cover images.

7. A method as recited in claim 5, wherein the additional information comprises a website address on the Internet which includes information further describing contents of magazines represented by the magazine cover images.

8. A method as recited in claim 7, wherein the additional information comprises a hyperlink.

9. A method as recited in claim 1, wherein the stack of image data is created in response to a request by a user.

10. A method as recited in claim 9, wherein the order in which the selected images are to be displayed can vary from user to user, based on information included in the request.

11. A method as recited in claim 9, wherein the images selected to be included in the stack can vary from user to user, based on information included in the request.

12. A method as recited in claim 11, wherein the information included in the request is in a form of a cookie retrieved from the user's computer.

13. A method as recited in claim 11, wherein the information included in the request is used to retrieve user preference information from a database of user preference information.

14. A server providing web-based stacked images, comprising:
a database of image data, the image data representing a plurality of separate images;
a display for displaying at least a portion of the plurality of separate images; and
a processing unit for creating a stack of image data by individually selecting images from the displayed images, wherein each time an image is selected, the image data representing the selected image is pushed onto the stack of image data, the stack of image data including information defining an order in which the selected images are to be displayed, the processing unit assigning a tag to the stack of image data, uniquely identifying the stack of image data, the tag being included in the stack of image data.

15. A server as recited in claim 14, wherein the processing unit selects additional information to be included with the stack of image data, the additional information relating to the images in the stack of image data.

16. A server as recited in claim 15, wherein the additional information includes tags correlating portions of the additional information to corresponding images.

17. A server as recited in claim 15, wherein a portion of the additional information corresponding to an image on a top of the stack is displayed when each image is displayed on the top of the stack.

18. A server as recited in claim 15, wherein the images comprise magazine cover images.

19. A server as recited in claim 18, wherein the additional information further describes contents of magazines represented by the magazine cover images.

20. A server as recited in claim 18, wherein the additional information comprises a website address on the Internet which includes information further describing contents of magazines represented by the magazine cover images.

21. A server as recited in claim 20, wherein the additional information comprises a hyperlink.

22. A server as recited in claim 14, wherein the stack of image data is created in response to a request by a user.

23. A server as recited in claim 22, wherein the order in which the selected images are to be displayed can vary from user to user, based on information included in the request.

24. A server as recited in claim 22, wherein the images selected to be included in the stack can vary from user to user, based on information included in the request.

25. A server as recited in claim 24, wherein the information included in the request is in a form of a cookie retrieved from the user's computer.

26. A server as recited in claim 24, wherein the information included in the request is used to retrieve user preference information from a database of user preference information.

27. A datastream for transmission across the Internet, comprising:
image data representing a plurality of images;
information describing an order in which the plurality of images are to be displayed on a user's computer, wherein the images are arranged in a stack, with only a top image to be displayed at a time;
descriptive information describing aspects of the plurality of images, wherein the descriptive information includes information correlating portions of the descriptive information to at least a portion of each of the plurality of images.

28. A datastream as recited in claim 27, wherein the descriptive information comprises an address of a website on the Internet.
